(19) United States
(12) Patent Application Publication
(10) Pub. No.: US 2009/0167135 A1
(43) Pub. Date: Jul. 2, 2009

(54) Spark plug

(76) Inventor: Robert Morin, Venice, CA (US)

Correspondence Address: Robert Morin, 11 27th Ave., #202, Venice, CA, 90291, US

(21) Appl. No.: 12/380,541

(22) Filed: Mar. 2, 2009

Related U.S. Application Data
(63) Continuation-in-part of application No. 11/239,564, filed on Sep. 28, 2005, now abandoned.
(60) Provisional application No. 60/613,221, filed on Sep. 28, 2004.

(51) Int. Cl. H01T 13/20

(52) U.S. Cl. 313/141

(57) ABSTRACT

An improved spark plug having a one-piece electrode of a particular alloy material, terminating in a firing end that has a plurality of extending tines, each tine having a downwardly end that is within a prescribed distance from the plug's firing ring.

### CROSS-REFERENCE TO RELATED APPLICATIONS

This application is a continuation-in-part of patent application Ser. No. 11/239,564, filed Sep. 28, 2005; which claimed priority to Provisional Patent Application Ser. No. 60/613,221, filed with the Patent and Trademark Office on Sep. 28, 2004.

### STATEMENT REGARDING FEDERALLY SPONSORED RESEARCH AND DEVELOPMENT

This invention was not developed as the result of any federally sponsored research and development.

### BACKGROUND OF THE INVENTION

The invention relates to spark plugs for use in internal combustion engines and more specifically to spark plugs having a grounding anode extension that has oval shaped port holes and a multi-point central electrode of a particular alloy composition, and plated to produce sparks from multiple locations around the periphery of the anode.

A spark plug provides the ignition source in an internal combustion engine. It is a device one end of which extends into a cylinder of an internal combustion engine, exposing two electrodes with a gap there-between within the cylinder. A compressed mixture of fuel vapor and air in a cylinder is ignited by establishing an electrical discharge across the gap between the two electrodes at pre-determined timed intervals. Because the spark plug is such an integral part of the proper and efficient operation of the combustion engine, efforts to improve the performance of the spark plug so as to improve the performance of the engine, have been non-stop.

The physical structure of a traditional spark plug is essentially a concentric arrangement of 1) a cylindrical high-voltage center electrode, 2) an insulator which surrounds and isolates the center electrode, and a 3) threaded shell which surrounds the insulator. The threaded shell screws into a tapped hole that provides access to the interior of a cylinder. Typically, a metallic appendage fused to the rim of the shell and in close proximity to the center electrode acts as the ground electrode.

The first spark plug was invented by Etienne Lenior in France in 1885. Over the years improvements have been made by using stronger or more durable materials which allowed a somewhat longer life span. Present-day conventional spark plugs use a center electrode consisting of a nickel-chrome steel hollow sheath surrounding a copper-alloy center member.

The purpose of this structure is to protect the center electrode from the corrosive environment of the cylinder while at the same time enabling the rapid dissipation of heat from the tip of the center electrode to the cylinder head and to ceramic insulator. In more recent years, new materials like platinum, gold palladium, copper-core fine wire, tapered tip, and split-tip plugs have become available at considerable additional cost as compared with conventional ground-wire tip spark plugs. Today's premium high-performance plugs feature designs that provide greater durability, which in turn translates into better fuel economy and stronger long-term performance.

On the surface, a spark plug's job is simple: to create an electrical arc in the combustion chamber in order to ignite the air-fuel mixture. But in reality, it is a more complicated process than what first appears. First, it takes up to 40,000 volts supplied by the ignition coil) to create an arc that will jump from the center electrode to ground in the combustion chamber's pressurized environment. As the plug wears, the edges of the modern conventional electrode gradually round off, thereby increasing the voltage required to jump the gap. This is the main reason that spark plugs need to be replaced on a regular basis. As the voltage goes up, the chance of misfire fouling and pre-ignition increases, thereby causing rough idling, poor performance, reduced gas mileage, and increased emissions.

Prior art patent that have addressed various improvements or claimed improvements to the spark plug include U.S. Pat. Nos. 5,767,613, 5,731,655, 5,280,214, 5,21,676, 3,968,144, 5,623,179, 5,107,168, 6,628,049, and 6,608,430. None of these, however, provide, disclose or suggest the novel aspects of the design hereinafter set forth, described and claimed.

### BRIEF SUMMARY OF THE INVENTION

The invention is an improved spark plug of the type that provides for greater heat exchange from the electrode through the insulator, means for more opportunity so the spark can choose the path of least resistance, means for greater electricity flow from the terminal to the electrode, means for creating turbulence in the vicinity of the spark to move more of the air-fuel mixture into the space adjacent the spark, all of which will provide for hotter spark and longer life of the spark plug. The spark plug of this invention has a one-piece electrode as opposed to being constructed of a two-piece element including a cap that in the prior art was typically welded to the post end of the electrode. The electrode of this invention is also comprised of a unique material, which can be plated but does not need to be.

The insulator portion of the plug comprise a novel ceramic composition with 2% to 5% titanium alloy having greater that 90% titanium, and a grain size of 1 to 3 microns. The electrode portion comprises a larger, more massive core than in prior art plugs, so as to facilitate heat removal, and combined with a more massive shell, a smaller insulation ring having a number of oval shaped ports in the grounding ring, multiple points having a novel alloy, provide enhanced performance.

### BRIEF DESCRIPTION OF THE DRAWINGS

FIG. 1 is a perspective view of a first embodiment of the improved spark plug.

FIG. 2 is a side view of a first embodiment of the improved spark plug.

FIG. 3 is a section view taken along line A-A in FIG. 2

FIG. 4 is a isolated view showing just the top portion of the plug shown in the preceding Figures.

FIG. 5 is a side view taken along line B-B in FIG. 4.

FIG. 6 is a perspective view of one end of a preferred shape for the firing end of the one-piece electrode

### DETAILED DESCRIPTION OF THE PREFERRED EMBODIMENT

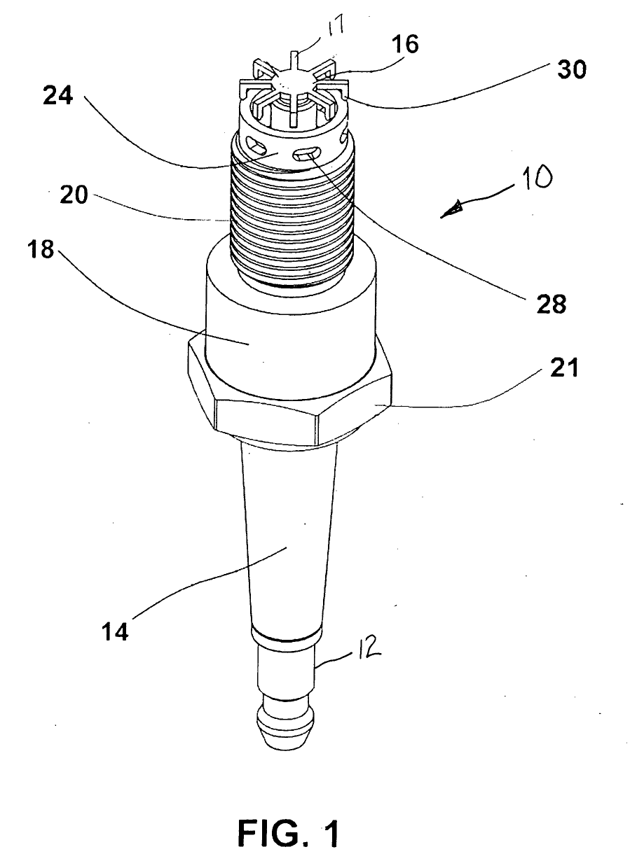

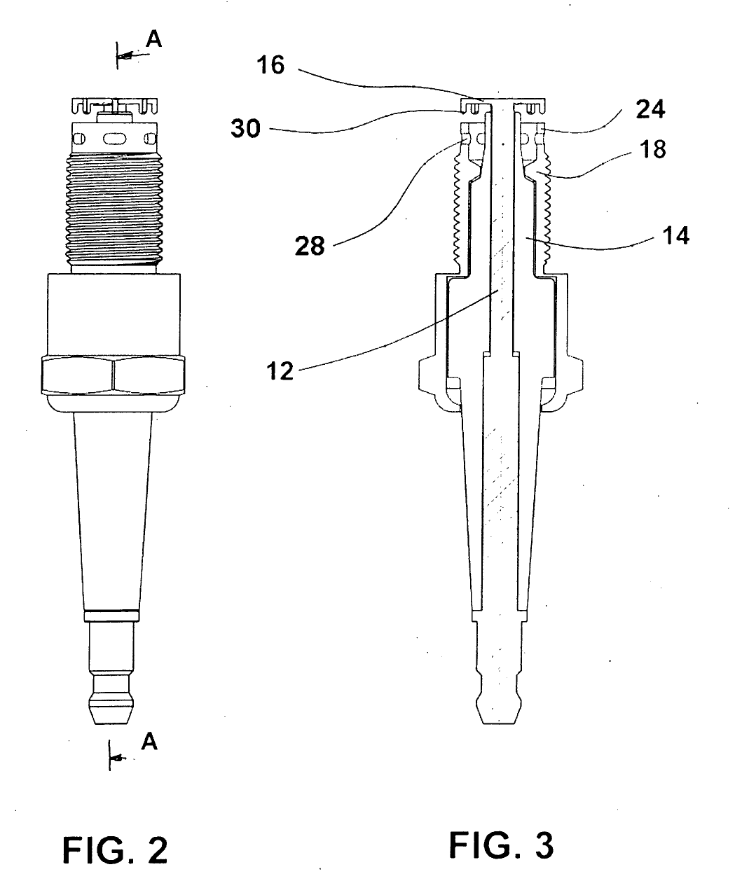

A first embodiment of the improved spark plug 10 is shown in FIG. 1 in which a center electrode 12 extends through the body 14 of the spark plug to culminate in the firing end 16. The center electrode 12 and a firing end 16 are of single piece construction. The firing end 16 preferably has eight tines 17. The preferred composition for the entire electrode 12 is an alloy of CARBON 0.10 NICKEL/balance CROMIUM 20.0-23.0 IRON 5.00 SILICON 0.50 MANGANESE 0.50 SULFUR 0.015 PHOSPHORUS 0.015 MOLYBDENUM 8.00-10.00 TITANIUM 0.40 COBALT 1.00 COLUMBIUM+TANTALUM 3.15-4.15 ALUMINUM 0.40. The body 14 is substantially constructed of an insulating material (preferably with 2% to 5% titanium alloy having greater that 90% titanium, and a grain size of 1 to 3 microns) so as to electrically isolates the center electrode 12 from the shell 18, a portion 20 of which is threaded for attachment to the engine block and a portion 21 of which is in the traditional form of a nut so that the plug can be inserted and removed by an appropriate tool.

Above the shell 18 is a firing ring 24 made of a precious metal alloy. The purpose of the ring 24 is to provide the ground to which the spark from the firing end of the electrode leaps

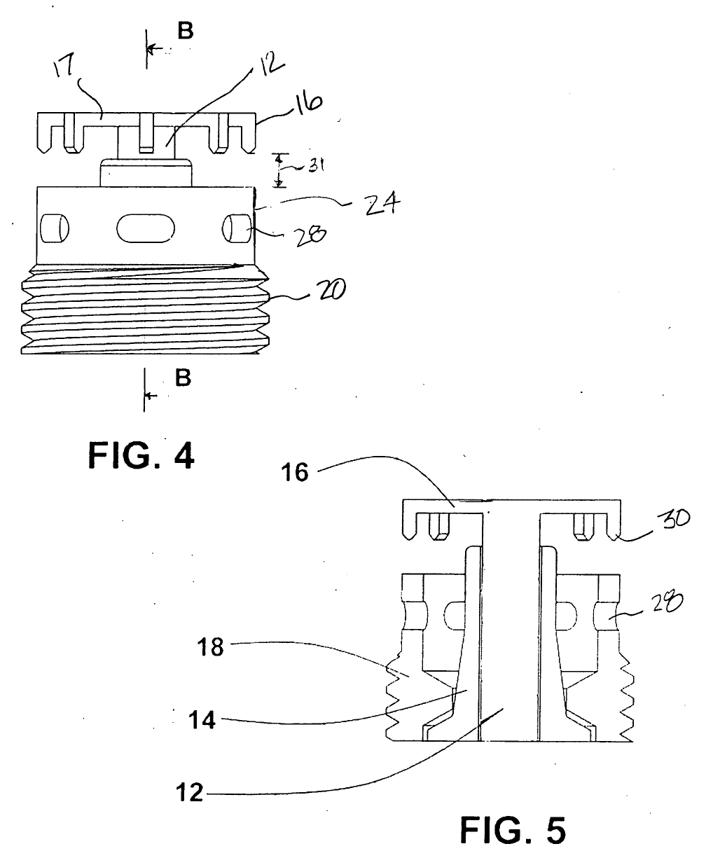

The ring 24 has a series of elongated aperture or holes 28 around its periphery. As will be noted, the ring 24 is significantly larger than in traditional spark plug design, resulting in the firing end of the plug extending deeper into the engine's cylinder upon insertion. As seen in FIG. 4, the holes 28 preferably are oblong in shape and extend around a large portion of the base's circumference so as to provide a large area for gas to escape and to improve turbulent flow of the air-gas mixture in the spark area. While many different variations are possible, a base length of up to approximately 1 inch is shown.

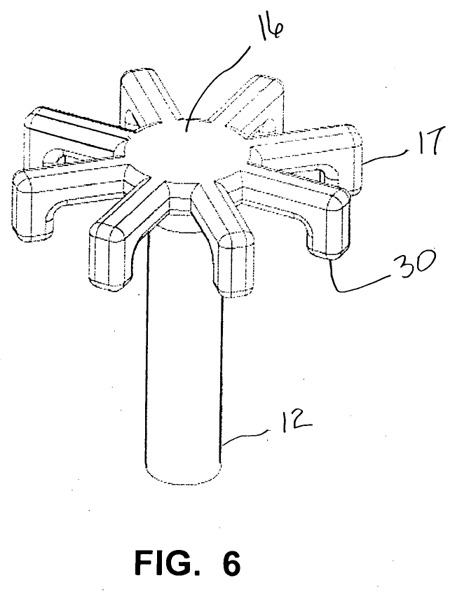

FIG. 6 shows in perspective the preferred, one-piece firing end 16 of the electrode, and also the fine detail of the preferred shape of the extending prongs. The firing end 16 preferably has 8, equally spaced apart tines, each of which terminates in a downwardly (toward the firing ring 24) tip 30. The preferred separation (see dimension 31) between the bottom end of the tip 30 and the upper edge of the firing ring 24 is less than 0.0001 inches. This multiple tip arrangement allows for the spark to follow the path of least resistance, which may change as one tip becomes impaired. This greatly extends the useful life of the plug.

The improved spark plug described herein is designed to reduce emissions and make the combustion process more efficient, thereby extending the spark plug's service life. With the center electrode extended further into the combustion chamber, this improved spark plug provides the means for more effectively accomplishing the combustion process by initiating the process further into the fuel-air mixture and to provide more surface area to be cooled by incoming gas, as well as increase flame front-kernel without obstruction from a ground wire.

Although preferred embodiments have been shown and described, the disclosed invention and the protection afforded by this patent are not limited thereto, but are of the full scope of the following claims, and equivalents thereto.

What is claimed is:

1. A spark plug comprising:
a) a body having an insulator, said insulator having a composition that is substantially a ceramic with 2% to 5% titanium alloy having greater that 90% titanium, and a grain size of 1 to 3 microns;
b) a central portion on said body;
c) a portion of said central portion comprising exterior threads;
d) an electrically conducive, substantially elongated firing ring extending above said exterior threads; and
e) an electrode extending through said body and terminating in a firing end, and being of one-piece construction.

2. The spark plug of claim 1, wherein said electrode has a composition that is substantially CARBON 0.10 NICKEL/balance CROMIUM 20.0-23.0 IRON 5.00 SILICON 0.50 MANGANESE 0.50 SULFUR 0.015 PHOSPHORUS 0.015 MOLYBDENUM 8.00-10.00 TITANIUM 0.40 COBALT 1.00 COLUMBIUM+TANTALUM 3.15-4.15 ALUMINUM 0.40.

3. The spark plug of claim 1 in which said firing end has a number of tines, each of which has a downwardly extending tip that is within 0.0001 inches of the upper edge of said firing terminating end of said firing ring.
